(19) United States
(12) Patent Application Publication
(10) Pub. No.: US 2026/0285044 A1
(43) Pub. Date: Sep. 24, 2026

(54) LIQUID DISCHARGE SUBSTRATE AND LIQUID DISCHARGE HEAD USING LIQUID DISCHARGE SUBSTRATE

(71) Applicant: CANON KABUSHIKI KAISHA, Tokyo (JP)

(72) Inventor: TAKASHI SUGAWARA, Kanagawa (JP)

(21) Appl. No.: 19/565,958

(22) Filed: Mar. 13, 2026

(30) Foreign Application Priority Data
Mar. 18, 2025 (JP) 2025-043764

(51) Int. Cl. B41J 2/14

(52) U.S. Cl. CPC B41J 2/1433; B41J 2/14233; B41J 2002/14306; B41J 2002/14411; B41J 2002/14491

(57) ABSTRACT

A liquid discharge substrate includes a flow path substrate including a discharge port and a flow path, a support substrate including an inlet path, a concave portion, and an inlet path wall provided between the inlet path and the concave portion, and a flexible member that covers the concave portion, and is bonded to the inlet path wall of the support substrate and to an outer edge portion of the support substrate along a first direction via a first bonding member, wherein the support substrate includes, in plan view, the inlet path extending in the first direction of the support substrate, and a bonding extension portion adjacent to the inlet path in the first direction and adjacent to an end portion of the concave portion in a second direction intersecting the first direction, and the first bonding member includes, in plan view, protruding portions that protrude into the concave portion.

### BACKGROUND

### Field of the Technology

The present disclosure relates to a liquid discharge substrate and a liquid discharge head using the same.

### Description of the Related Art

As an example of a liquid discharge head for discharging liquid droplets, an inkjet head mounted on an inkjet recording apparatus is known. The inkjet head includes a plurality of pressure chambers and discharge ports, and is configured to discharge liquid droplets from the discharge ports by applying pressure to liquid (ink) in the pressure chambers by a driving unit.

Here, pressure fluctuations that occur in a certain pressure chamber due to discharging of liquid droplets may propagate to other pressure chambers via a liquid flow path. As a result, there is a possibility of defective discharge due to so-called crosstalk.

In an example of a method for reducing the influence of crosstalk, a method of using a damper to attenuate pressure fluctuations is known. Japanese Patent Laid-Open No. 2017-159522 (Patent Literature 1) discloses a liquid discharge substrate in which a flexible member that functions as a damper is provided in a liquid flow path. The flexible member in Patent Literature 1 is installed on a partition wall between a common flow path and a damper chamber via a bonding member.

However, in a case where discharge ports are arranged at a higher density in order to achieve higher image quality in an inkjet head, the area of the partition wall between the common flow path and the damper chamber is small in the configuration of Patent Literature 1. This reduces the adhesion between the flexible member and the bonding member, which may cause a flexible film to peel off.

### SUMMARY

The present disclosure is directed to providing a technique for preventing peeling of a flexible member that functions as a damper in a case where the flexible member is arranged on a liquid discharge substrate.

A liquid discharge substrate of the present disclosure includes a flow path substrate including a discharge port that discharges liquid and a flow path that supplies the liquid to the discharge port, a support substrate including an inlet path that communicates with the flow path, a concave portion provided corresponding to at least a part of the flow path, and an inlet path wall provided between the inlet path and the concave portion, and a flexible member that covers the concave portion, and is bonded to the inlet path wall of the support substrate and to an outer edge portion of the support substrate along a first direction via a first bonding member, in which the support substrate includes, in plan view, the inlet path extending in the first direction of the support substrate, and a bonding extension portion adjacent to the inlet path in the first direction and adjacent to an end portion of the concave portion in a second direction intersecting the first direction, and the first bonding member includes, in plan view, protruding portions that protrude into the concave portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of a liquid discharge apparatus to which the present disclosure can be applied;

FIG. 2 is a perspective view of various liquid discharge head modules to which the present disclosure can be applied;

FIG. 3A is a schematic diagram of a liquid discharge head module according to the present disclosure, including views of a liquid discharge substrate of the liquid discharge head module according to the present disclosure as seen from a discharge port side and as seen from the opposite side;

FIG. 3B is a schematic diagram of the liquid discharge head module of the present disclosure, and is a schematic cross-sectional perspective view taken along line IIIB-IIIB in FIG. 3A;

FIG. 3C is a schematic diagram of the liquid discharge head module according to the present disclosure, and is a partially enlarged view of FIG. 3B;

FIG. 4A is a schematic diagram illustrating the liquid discharge substrate according to the present disclosure, and is a planar perspective view illustrating a part of the liquid discharge substrate in an enlarged manner;

FIG. 4B is a schematic diagram illustrating the liquid discharge substrate according to the present disclosure, and is a cross-sectional view taken along line IVB-IVB in FIG. 4A;

FIG. 4C is a schematic diagram illustrating the liquid discharge substrate according to the present disclosure, and is a cross-sectional view taken along line IVC-IVC in FIG. 4A;

FIG. 4D is a schematic diagram illustrating the liquid discharge substrate according to the present disclosure, and is a cross-sectional view taken along line IVD-IVD in FIG. 4A;

FIG. 5 is a schematic cross-sectional perspective view of a first liquid discharge substrate of the present disclosure;

FIGS. 6A1 and 6A2 are schematic cross-sectional views of the liquid discharge substrate according to the present disclosure, in which FIGS. 6A1 and 6A2 are schematic cross-sectional views of the first liquid discharge substrate according to the present disclosure and a modification thereof, respectively;

FIGS. 6B1 to 6B3 are schematic plan views of the liquid discharge substrate of the present disclosure, in which FIGS. 6B1 and 6B2 are cross-sectional views taken along VIb1-VIb1 and VIb2-VIb2 in FIGS. 6A1 and 6A2, respectively, and FIG. 6B3 is a diagram illustrating a modification of FIGS. 6B1 and 6B2;

FIG. 7A is a schematic diagram for describing the liquid discharge substrate, and is a plan view of the liquid discharge substrate;

FIG. 7B is a schematic diagram for describing the liquid discharge substrate, and is a cross-sectional perspective view in a case where the liquid discharge substrate is cut along line VIIC-VIIC in FIG. 7A;

FIG. 7C is a schematic diagram for describing the liquid discharge substrate, and is a cross-sectional view taken along line VIIC-VIIC in FIG. 7A;

FIG. 8A is a schematic diagram for describing a liquid discharge substrate according to one embodiment, and is a plan view of the liquid discharge substrate;

FIG. 8B is a schematic diagram for describing the liquid discharge substrate according to the one embodiment, and is a cross-sectional perspective view in a case where the liquid discharge substrate in FIG. 8A is cut along line VIIIC-VIIIC;

FIG. 8C is a schematic diagram for describing the liquid discharge substrate according to the one embodiment, and is a cross-sectional view of the liquid discharge substrate taken along line VIIIC-VIIIC in FIG. 8A;

FIG. 9 is a plan view illustrating a modification of the liquid discharge substrate in one embodiment;

FIG. 10A is a cross-sectional perspective view for describing a bonding member protruding to the inner side of a concave portion of a liquid discharge substrate, and is a cross-sectional perspective view of the concave portion of a comparative example;

FIG. 10B is a cross-sectional perspective view for describing a bonding member protruding to the inner side of a concave portion of a liquid discharge substrate, and is a cross-sectional perspective view of the inner side of the concave portion of the present disclosure;

FIG. 11 is a plan view illustrating a comparative example of a liquid discharge substrate;

FIG. 12 is a cross-sectional view for describing the bonding member protruding to the inner side of the concave portion;

FIG. 13A is a schematic diagram for describing a liquid discharge substrate according to one embodiment, illustrating an example in which a plurality of grooves are formed;

FIG. 13B is a schematic diagram for describing a liquid discharge substrate according to one embodiment, illustrating an example in which a continuous groove is provided;

FIG. 13C is a schematic diagram for describing a liquid discharge substrate according to one embodiment, and is a cross-sectional view taken along line XIIIC-XIIIC in FIG. 13B;

FIG. 14 is a diagram for describing manufacturing processes of a liquid discharge substrate in one embodiment;

FIG. 15 is a diagram for describing the position at which a flexible member is to be formed; and

FIG. 16 is a diagram illustrating a modification of a liquid discharge substrate.

### DESCRIPTION OF THE EMBODIMENTS

Hereinafter, some embodiments according the present disclosure will be described with reference to the drawings. However, unless otherwise specified, the dimensions, materials, shapes, relative arrangement, and the like of the components described in the embodiments are not intended to limit the scope of the present disclosure to only those. In addition, unless otherwise specified, the materials, shapes, and the like of the components that have been described once in the following description are the same in the subsequent description. Well known techniques or known techniques in the art can be applied to the configurations and processes not specifically illustrated or described. In addition, the present disclosure is not limited to these embodiments, and not all of the combinations of features described in each embodiment are necessarily essential to the solutions of the present disclosure.

In the description of the present specification, for a liquid discharge substrate, a liquid discharge head, and a liquid discharge apparatus of the present disclosure, directions may be defined by using an X-axis, a Y-axis, and a Z-axis. These axes are indicated by the arrowed directional axes illustrated in each figure.

In the present specification, in a case where the direction of each axis is specified, if the direction of the X-, Y-, or Z-axis is indicated by an arrow on one side, the direction in which the arrow is pointing is defined as the “+” direction of the axis. That is, in a case where the direction is indicated by an arrow on one side, as for the “+” or “−” direction of each axis, the “+” direction is the direction in which the arrow is pointing, and the “−” direction is the direction opposite to the direction in which the arrow is pointing. In addition, in a case where the directions of the X-, Y- or Z-axis are indicated by arrows on both sides, the arrows of each axis are marked with “+” and “−” directions to indicate the directions of that axis. Furthermore, in the present specification, in a case where the direction of an axis is referred to without specifying the “+” or “−” direction, the direction is simply referred to as an “X-axis direction,” a “Y-axis direction,” or a “Z-axis direction.”

In addition, in the present specification, it is assumed that the height direction of the liquid discharge head, the liquid discharge substrate, the liquid discharge apparatus, and the like (that is, the gravitational direction) is the Z-axis direction. It is assumed that the side of the Z-axis direction (gravitational direction) in which gravity is applied (also referred to as the gravity side in the present specification) is the +Z direction, and the side opposite to the side of the Z-axis direction (gravitational direction) in which gravity is applied (also referred to as the anti-gravity side in the present specification) is the −Z direction. In the present specification, surfaces of a member may be described by using the terms an “upper surface” and a “bottom surface.” Among these surfaces, the “upper surface” refers to the surface facing the +Z direction, and the “bottom surface” refers to the surface facing the −Z direction. In addition, the X-axis direction, the Y-axis direction, and the Z-axis direction are perpendicular to each other.

In each of the drawings for describing the liquid discharge substrate of the present disclosure, the X-axis direction particularly indicates the width direction of the liquid discharge substrate. The Y-axis direction indicates the depth direction of the liquid discharge substrate, and is the longitudinal direction (also referred to as a first direction) of the liquid discharge substrate. The Z-axis direction indicates the height direction (gravitational direction) of the liquid discharge substrate.

In the present specification, “liquid” includes arbitrary liquid that can be applied to a recording medium so as to be used for forming an image, printing, or processing of the recording medium or the like. Accordingly, “liquid” in the present specification is a concept that encompasses all liquids that can be used for recording, printing, or processing. In addition, the concept of recording is not particularly limited, and can also be applied to industrial applications and the like. For example, the concept can be used for applications such as the production of biochips, printing of electronic circuits, and the production of semiconductor substrates.

In the present specification, the terms “liquid” and “ink” are used. In the present disclosure, these terms are used as concepts that encompass any liquid that can be used for recording. In addition, “liquid” and “ink” refer to arbitrary liquid medium that can be applied to a recording medium so as to be used for forming an image, printing, processing of the recording medium, and the like. Accordingly, in the present specification, the terms “liquid” and “ink” are used as having interchangeable meanings.

In the present specification, “flexibility” or “having flexibility” means being soft, being able to be bent, or having such properties.

### First Embodiment

### <Liquid Discharge Apparatus>

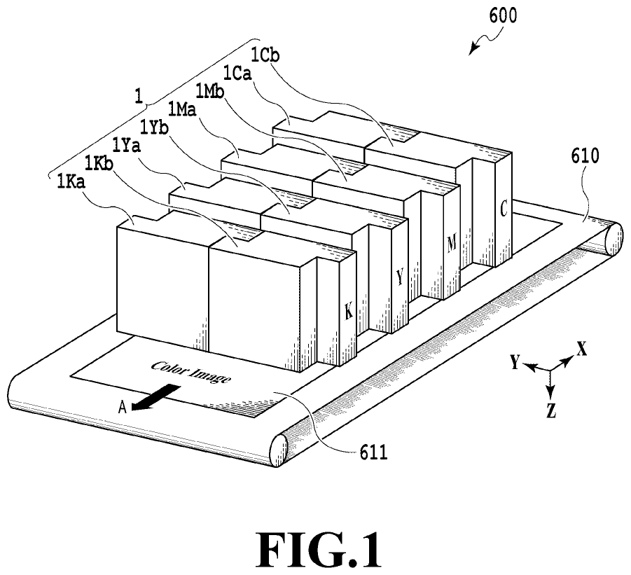

FIG. 1 is a schematic perspective view for describing a general configuration of a liquid discharge apparatus 600 according to an embodiment of a liquid discharge apparatus to which the present disclosure can be applied.

The liquid discharge apparatus 600 of the present embodiment is a one-pass type that records an image on a recording medium 611 in one movement of the recording medium, and discharge ports 111 are arranged so as to correspond to the entire width of the recording medium 611. The liquid discharge apparatus 600 is provided with a liquid discharge head module 1 in a manner that is, for example, detachable.

The recording medium 611 is conveyed in the direction of an arrow A by a conveying unit 610, and recording is performed by the liquid discharge head module 1. In addition, in order to perform color recording, the liquid discharge head module 1 including a plurality of colors is used. This module includes eight recording heads 1Ca, 1Cb, 1Ma, 1Mb, 1Ya, 1Yb, 1Ka and 1Kb that discharge cyan (C) ink, magenta (M) ink, yellow (Y) ink, and black (K) ink, which are liquid. In the present specification, in the case where it is unnecessary to distinguish between the liquid discharge heads of each of the colors, the liquid discharge head module will be collectively referred to as the “liquid discharge head 1.” The liquid discharge head module of the present disclosure can be implemented in any form including the example in FIG. 1, and other forms are also not limited to the one illustrated in FIG. 1.

### <Configuration of Liquid Discharge Head>

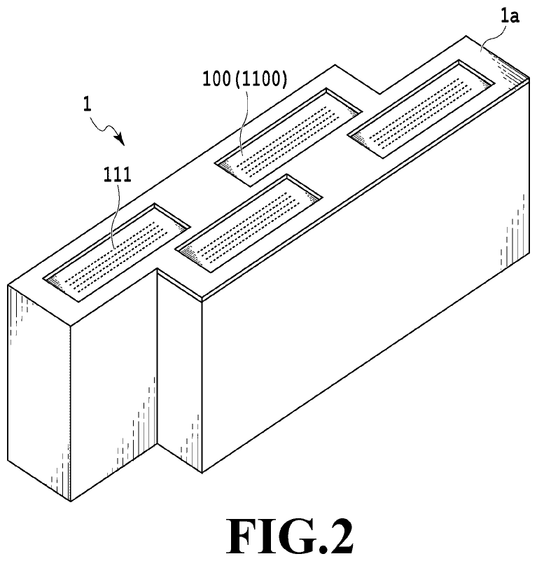

FIG. 2 is a perspective view of various liquid discharge head modules 1 to which the present disclosure can be applied. In the liquid discharge head module 1, a plurality of liquid discharge substrates 100 (or 1100) each having discharge ports 111 are arranged in a liquid discharge head main body 1a. The liquid (ink) to be discharged is supplied from a liquid tank (not illustrated) to the liquid discharge substrates 100 (or 1100) via a common supply port (not illustrated) of the liquid discharge head main body 1a.

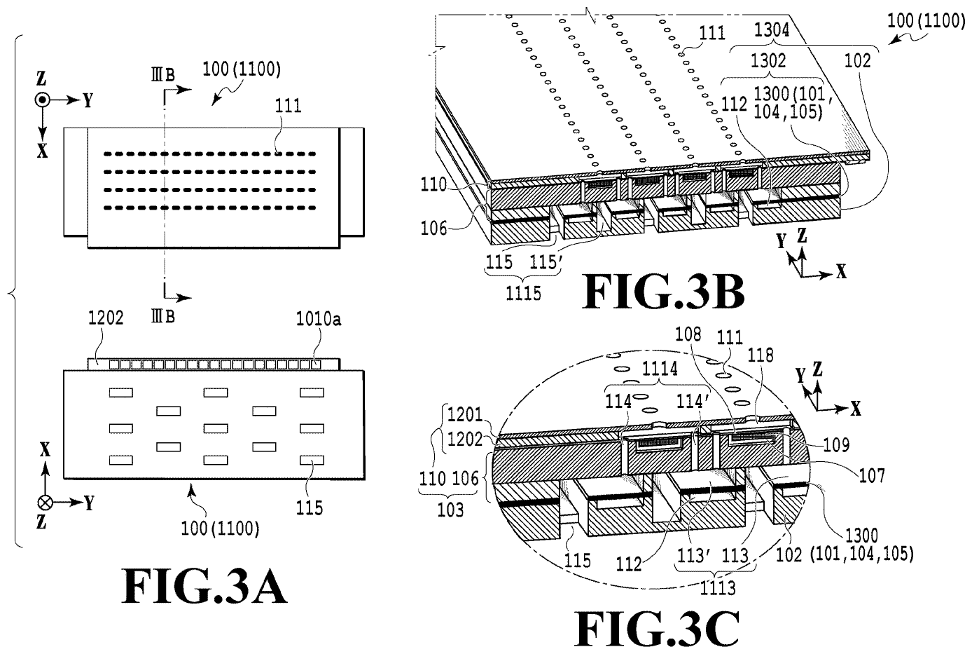

Referring to FIGS. 3A to 3C, FIGS. 4A to 4D, and FIG. 5, the liquid discharge substrate will be described. These figures illustrate the liquid discharge substrate of the liquid discharge head module of the present disclosure. The liquid discharge substrate described with reference to these figures is a liquid discharge substrate having a circulation configuration in which liquid flows in one direction, and is an example of the liquid discharge substrate of the present disclosure. A more specific description of the liquid discharge substrate of the present disclosure will be given in detail in the section “Description of First Liquid Discharge Substrate 100 and Modification 1100 of First Liquid Discharge Substrate,” which will be described later.

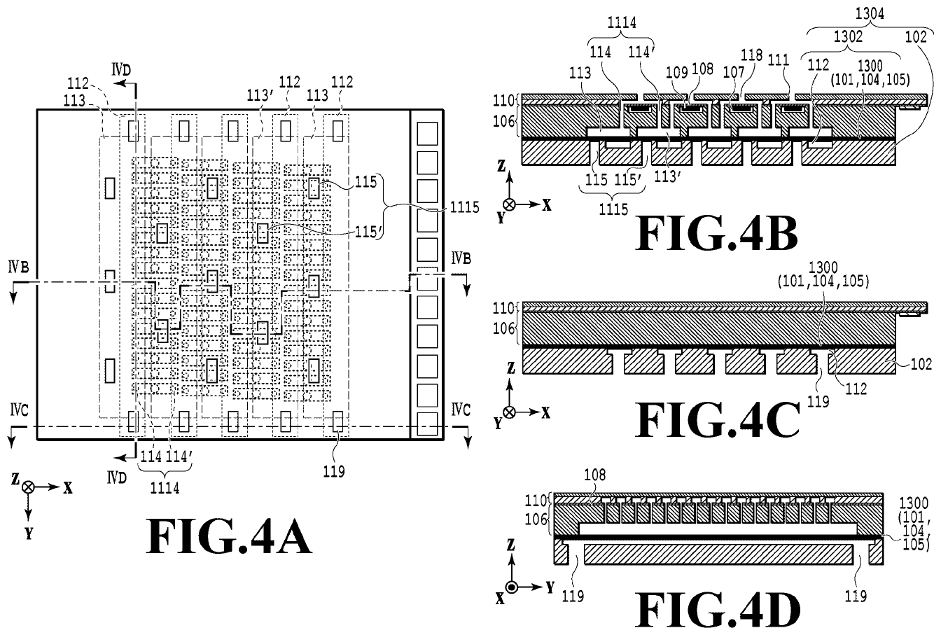

FIG. 3A illustrates views of the liquid discharge substrate of the liquid discharge head module of the present disclosure as viewed from the discharge ports side and as viewed from the opposite side, and FIG. 3B is a schematic cross-sectional view taken along line IIIB-IIIB in FIG. 3A. FIG. 3C is a partially enlarged view of FIG. 3B. The liquid discharge substrate 100 (or 1100) includes three substrates, i.e., a first substrate member 106, a second substrate member 110, and a damper substrate 1304. The second substrate member 110 includes a nozzle substrate 1201 and an actuator substrate 1202. In addition, the damper substrate 1304 includes a flexible member 101, a support substrate 102, a first bonding member 104, a second bonding member 105, concave portions 112, and common openings 1115. The discharge ports 111 are formed in the nozzle substrate 1201, and the plurality of discharge ports 111 are arranged along the Y-axis direction of the substrate to form discharge port columns, and further form a plurality of discharge port columns in the X-axis direction. The actuator substrate 1202 includes pressure chambers 118, vibration plates 108, and pressure generating elements (for example, a piezoelectric elements) 109. The flow path substrate 103 includes individual flow paths 1114 (including the second flow path 114), a common flow path (first flow path) 113, and spaces each serving as a void (also referred to as an accommodation space in the present specification) 107 that surrounds the pressure generating element (for example, a piezoelectric element) 109. In the case where the pressure generating element 109 is a piezoelectric element, the void 107 is required to efficiently transmit the deformation of the piezoelectric element caused by the application of voltage to the vibration plate 108. The damper substrate 1304 includes a damper film (the flexible member 101, the bonding member 104, and the bonding member 105) 1300, the concave portions 112, and the common openings 1115 (see FIG. 4B). Liquid (ink) is supplied to the nozzle substrate 1201 from the common openings 1115 formed in the damper substrate 1304 via the flow path substrate 103, and the liquid (ink) is discharged from the discharge ports 111 and applied to the recording medium 611. An electrical substrate (not illustrated) for supplying the power and signals required to discharge liquid is arranged in the liquid discharge head main body 1a, and is connected to a terminal 1010a of each liquid discharge substrate 100 (1100) by wiring (not illustrated). The liquid discharge head according to the present disclosure can be implemented in any form including the example illustrated in FIG. 2, and other forms are also not limited. For example, the liquid discharge head of the present disclosure can include a liquid discharge substrate that will be described later, a housing capable of accommodating liquid, and an electric connection portion that transmits power and control signals to the liquid discharge substrate.

### (Description of Discharge Port Arrangement, Damper Arrangement, and Air Communication Port)

FIG. 4A is a planar perspective view illustrating a part of the liquid discharge substrate (for example, 1100) of the liquid discharge head of the present disclosure in an enlarged manner, and is a view as seen from the surface opposite to the discharge port 111 side. FIG. 4B is a cross-sectional view taken along line IVB-IVB in FIG. 4A, and FIG. 4C is a cross-sectional view taken along line IVC-IVC in FIG. 4A. In addition, FIG. 4D is a cross section taken along line IVD-IVD in FIG. 4A. As illustrated in FIG. 4A, a plurality of discharge port columns aligned in the X-axis direction are formed in the liquid discharge head 1. In the plurality of discharge port columns, one unit is constituted by the discharge ports 111, the individual flow paths 1114 communicating with the pressure chamber 118, and the pressure generating element (for example, a piezoelectric element) 109 that generates pressure in the pressure chamber 118. As illustrated in FIG. 4B, the pressure generating element (for example, a piezoelectric element) 109 for discharging liquid by pressure is arranged at a position corresponding to each discharge port 111. Along each discharge port column, an individual supply flow path (also referred to as the second flow path in the present disclosure) 114 that forms the individual flow path 1114 extends on one side, and an individual collecting flow path 114′ that forms the individual flow path 1114 extends on the other side. The individual supply flow path (the second flow path) 114 and the individual collecting flow path 114′ are flow paths that are provided in the liquid discharge substrate 100 and extend in the Z-axis direction, and are each in communication with the discharge ports 111. In addition, the individual supply flow path (the second flow path) 114 and the individual collecting flow path 114′ are connected to the common flow path 1113 including the common supply flow path (also referred to as the first flow path in the present specification) 113 and a common collecting flow path 113′, respectively. The connection points between the individual supply flow path (the second flow path) 114, the individual collecting flow path 114′, the common supply flow path (the first flow path) 113, and the common collecting flow path 113′ are individual openings. A damper structure (a chamber region formed by the damper film 1300 and the concave portion 112) 1302 including the concave portion 112 and the damper film (the flexible member 101, the bonding member 104, and the bonding member 105) 1300 is formed on the surface facing the surface having the individual openings. In the damper substrate 1304 in which the damper structure 1302 is formed, there are formed the common openings 1115 each including a common supply opening (also referred to as an inlet path in the present specification) 115 and a common collecting opening 115′ for connecting the common supply flow path (the first flow path) 113 and the common collecting flow path 113′, respectively. The common supply flow path (the first flow path) 113 and the common collecting flow path 113′ are formed to extend in the Y-axis direction, which is the direction along the discharge port column, and are formed on the surface opposite a discharging surface with respect to the pressure generating element (for example, a piezoelectric element) 109 in the Z-axis direction.

The concave portion 112 is open to the atmosphere by having air communication ports 119 (FIGS. 4A, 4C, and 4D) at both ends of the damper structure 1302 in the Y direction. In addition, since the damper structure 1302 is formed for each discharge port column (FIG. 4A), the pressure generating elements (for example, piezoelectric elements) 109 in each discharge port column can be arranged at high density. Furthermore, with the damper structure 1302, by extending the discharge port column in the Y-axis direction to ensure damping performance, the length in the X-axis direction can be shortened. By shortening the length of the damper structure 1302 in the X-axis direction, the distance between adjacent discharge port columns in the X-axis direction can be shortened. Accordingly, the liquid discharge substrate 100 (1100) and the liquid discharge head 1 can be made smaller. For example, in the example illustrated in FIGS. 4A to 4D, the pressure chambers 118 corresponding to the pressure generating elements (for examples, piezoelectric elements) 109 in each discharge port column have a length of 110 μm in the Y-axis direction, and the pressure chambers 118 and the discharge ports 111 are arranged at intervals of 150 dpi. In addition, by shifting the discharge port columns as described above in the Y-axis direction to form four columns, it becomes possible to arrange the discharge ports at a high density of 600 dpi with respect to the recording medium. Although the present embodiment has a configuration of 600 dpi with four discharge port columns, this is not a limitation, and a configuration of 1200 dpi with eight discharge port columns may be used.

Next, the flow of liquid within the liquid discharge substrate 100 (1100) will be described. If liquid is supplied to the common supply opening (the inlet path) 115, the liquid passes through the individual supply flow path (the second flow path) 114 of each element via the common supply flow path 113 (the first flow path), and passes through the pressure chamber 118 and the discharge ports 111. Then, the liquid passes through the individual collecting flow path 114′ and flows to the common collecting opening 115′ via the common collecting flow path 113′. Accordingly, the liquid supplied from the common supply opening (the inlet path) 115 flows to the common collecting opening 115′ and can be collected. By applying a pressure difference between the common supply opening (the inlet path) 115 and the common collecting opening 115′ from the outside by using a pump, hydraulic head pressure, or the like, the liquid can be circulated, and by suctioning the discharge ports 111 from the discharge surface and filling the discharge ports with the liquid while circulating the liquid, the discharge ports can be circulated.

The increased density due to the circulation of the discharge ports as described above results in a configuration in which each pressure chamber 118 is close to each other in the discharge port column or between the discharge port columns. In addition, adjacent discharge port columns share the supply and collecting flow paths. Therefore, there is a concern that pressure waves are transmitted to other pressure chambers 118 in the discharge port column or between the discharge port columns, resulting in crosstalk that affects the discharge characteristics. In the present embodiment, by arranging the damper structure 1302 along the direction of the discharge port column, which is the Y-axis direction in the figure, it is possible to absorb the pressure waves from crosstalk, while arranging the discharge ports at high density and making the liquid discharge head smaller.

The pressure generated in each pressure chamber 118 is transmitted through the individual supply flow path (the second flow path) 114 and the individual collecting flow path 114′ to the common supply flow path (the first flow path) 113 and the common collecting flow path 113′, thereby propagating the pressure to other pressure chambers 118. Therefore, in the present embodiment, the damper structure 1302 is provided at a position facing the individual supply flow path (the second flow path) 114 and the individual collecting flow path 114′. Accordingly, the pressure from the individual supply flow path (the second flow path) 114 and the individual collecting flow path 114′ can be absorbed before being transmitted to the common supply flow path (the first flow path) 113 and the common collecting flow path 113′. Therefore, the damper substrate 1304 is formed such that the damper structures 1302 and the common supply openings (the inlet paths) 115 or the common collecting openings 115′ are alternately arranged. In the present embodiment, on the paper surface of FIG. 4B, the flow paths and the damper structures are arranged in the order of, from the left side in the X-axis direction, the common supply opening (the inlet path) 115, the damper structure 1302, the common collecting opening 115′, and the damper structure 1302.

The liquid discharge head 1 may be used in different surrounding environments, such as high pressure, and high temperature and high humidity. In the case where the damper structure does not have the air communication port 119 as in the present embodiment, the inside of the damper structure is in a sealed state. Therefore, a change in atmospheric pressure may cause a pressure difference between the common flow path and the damper structure, resulting in expansion or contraction of the gas in the damper structure. In addition, if the liquid discharge head 1 is used in a relatively hot place or a cold place, the gas inside the damper structure thermally expands or thermally contracts, resulting in a change in pressure. If a pressure difference is generated between the inside and outside of the damper structure sealed as described above, a biasing force is accordingly applied on the damper film in a direction toward the outside or inside of the damper structure. In addition, in a state where this biasing force is applied, the damper film is already deformed accordingly, and the change characteristics (compliance characteristics) of the damper film are changed such that the damper film is less likely to be deformed in absorbing the pressure during discharging. As a result, there are cases where desired damping performance is not obtained, and the pressure waves of crosstalk may not be sufficiently absorbed.

On the other hand, by providing the air communication port 119, the pressure inside the damper structure can be made equal to the pressure of the surrounding environment even if the temperature or pressure of the surrounding environment changes. Accordingly, the pressure difference between the inside and outside of the damper structure can be reduced or eliminated. As a result, the compliance characteristics of the damper film 1300 can be maintained constant, and the pressure waves of crosstalk can be sufficiently absorbed.

In the present embodiment, as illustrated in FIGS. 4A to 4D, the air communication ports 119 are formed on the surface opposite the discharge surface (the discharge ports 111), at positions away from the common openings 1115, on the outer periphery of the liquid discharge substrate 100 (1100), and there are advantages as follows.

A member for supplying or collecting liquid to or from the common opening 1115 is arranged on the surface of the damper substrate 1304 on which the air communication ports 119 are formed. In addition, since the liquid is supplied, if the common opening 1115 and the air communication ports 119 are close to each other, the adhesive strength of the member may be decreased, which may cause leakage of the liquid. Therefore, by providing the air communication ports 119 at positions away from the common opening 1115, the adhesive strength of the member can be ensured. In addition, the common opening 1115 can be formed inside the liquid discharge substrate, which reduces the flow resistance of the liquid flowing to each pressure generating element 109, allowing for smooth supply or collection of the liquid. Furthermore, by arranging the air communication ports 119 on the outer circumferential side of both ends of the individual flow path 1114 of each discharge port column, the common opening 1115 may be brought closer to both ends of the individual flow path 1114.

In addition, by forming the air communication ports 119 on both ends of the damper structure 1302, the damper structure 1302 can be maintained at atmospheric pressure even if the air communication ports 119 on one side are blocked.

Furthermore, one embodiment, the air communication ports 119 may be formed to have a size equivalent to the size of the common opening 1115, thereby facilitating the processing of the damper substrate 1304. From the viewpoint of the strength of the damper substrate 1304, the depth (the length in the Z-axis direction) of the air communication ports 119 formed in the damper substrate 1304 can be greater than the depth of the damper structure 1302. The width (the length in the X-axis direction) of the air communication ports 119 is desirably smaller than the width of the damper structure 1302, which makes it possible to prevent foreign matters such as dust from entering the damper structure 1302. In other words, the width of the air communication ports 119 in a direction parallel to the surface of the damper substrate 1304 and intersecting the direction in which the damper structure 1302 extends can be smaller than the width of the damper structure 1302.

### <Description of First Liquid Discharge Substrate 100 and Modification 1100 of First Liquid Discharge Substrate>

Hereinafter, the first liquid discharge substrate 100 arranged in the liquid discharge head 1 in the present embodiment will be described in detail.

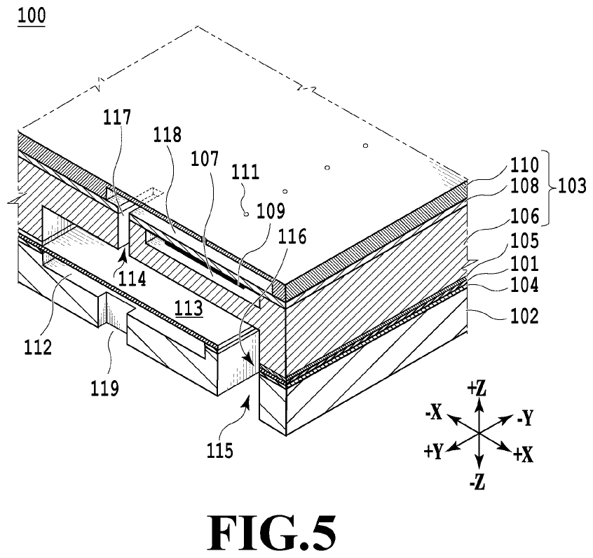

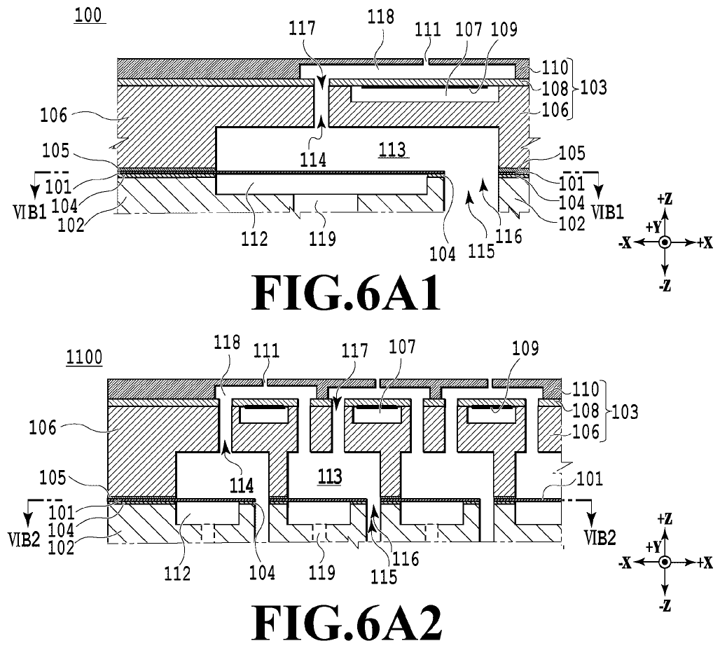

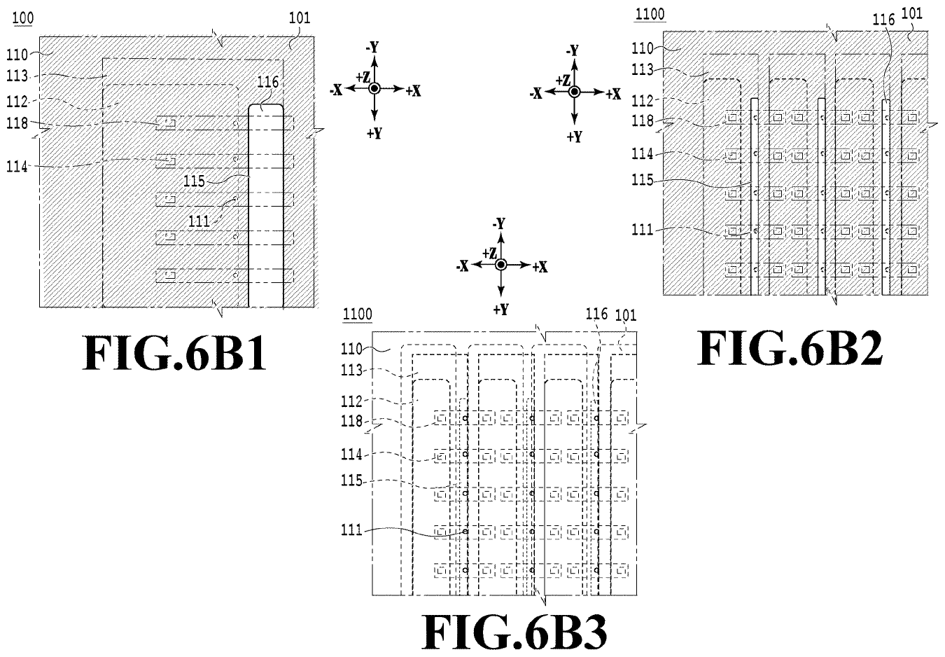

FIG. 5 is a schematic cross-sectional perspective view of the first liquid discharge substrate 100. FIGS. 6A1 and 6A2 and FIGS. 6B1 to 6B3 are cross-sectional views and plan views, respectively, for describing the bonded state of the flexible member 101. FIGS. 6A1 and 6B1 correspond to views of the first liquid discharge substrate 100 in FIG. 5 as seen from the +Y direction. In each of the drawings of the first liquid discharge substrate 100 and its modification 1100 of the present disclosure, the X-axis direction indicates the width direction of the first liquid discharge substrate 100. The Y-axis direction indicates the depth direction of the first liquid discharge substrate 100. The Z-axis direction indicates the height direction of the first liquid discharge substrate 100. It should be noted that the surface of the first liquid discharge substrate 100 facing the +Z direction is called the “upper surface” as appropriate. The surface of the first liquid discharge substrate 100 facing the −Z direction is called the “bottom surface” as appropriate. It should be noted that in the following description, the “upper surface” and the “bottom surface” are indicated together with directional axes with “+” and “−” directions.

The liquid discharge substrate in the present embodiment is also called the first liquid discharge substrate 100. Furthermore, as illustrated in FIGS. 6A2 and 6B2, a liquid discharge substrate that has a circulation configuration in which liquid flows in one direction relative to the first liquid discharge substrate 100 is also called the modification 1100 of the first liquid discharge substrate.

The first liquid discharge substrate 100 and the modification 1100 of the first liquid discharge substrate include the support substrate 102 that supports the flexible member 101 from the bottom surface (towards the +Z direction), and the flow path substrate 103 that supports the flexible member 101 from the upper surface (towards the −Z direction). A layer of the first bonding member 104 is formed between an upper surface (a surface facing the +Z direction) of the support substrate 102 and a bottom surface (a surface facing the −Z direction) of the flexible member 101. A layer of the second bonding member 105 is formed between an upper surface (a surface facing the +Z direction) of the flexible member 101 and a bottom surface (a surface facing the −Z direction) of the flow path substrate 103. In this manner, the flexible member 101 is sandwiched and fixed between the support substrate 102 and the flow path substrate 103 via the first bonding member 104 and the second bonding member 105. In this specification, the flexible member 101, the first bonding member 104, and the second bonding member 105 are also collectively referred to as the damper film.

The flow path substrate 103 includes the first substrate member 106 including the second bonding member 105 attached to its bottom surface (the surface facing the −Z direction). The accommodation space 107 that is concave from the upper surface toward the bottom surface (from the surface on the +Z-side toward the surface on the −Z-side) is formed in the first substrate member 106. The vibration plate 108 is bonded to the upper surface (the surface facing the +Z direction) of the first substrate member 106 so as to cover the accommodation space 107. The pressure generating element (for example, a piezoelectric element) 109 is arranged on the bottom surface (the surface facing the −Z direction) of the vibration plate 108. The pressure generating element (for example, a piezoelectric element) 109 is accommodated in the accommodation space 107.

The flow path substrate 103 further includes the second substrate member 110 bonded to the upper surface (the surface facing the +Z direction) of the vibration plate 108. The discharge ports 111 for discharging liquid as droplets are formed in an upper surface (a surface in the +Z direction) of the second substrate member 110. An example of the support substrate 102, the first substrate member 106, and the second substrate member 110 is, for example, a silicon substrate. The concave portions 112 that are concave from the upper surface toward a bottom surface (from a +Z-side surface toward a −Z-side surface) of the support substrate 102 are formed in the support substrate 102, and the air communication ports 119 are further formed in a bottom surface of the concave portions 112 (the surface facing the −Z direction). Furthermore, at positions different from the concave portions 112 of the support substrate 102, the inlet paths [the common supply openings (hereinafter simply referred to as the inlet paths)] 115, which are the third flow paths, are formed, and the inlet paths 115 penetrates the support substrate 102, the flexible member 101, and a part of the bottom surface side of the first substrate member 106. In the support substrate 102, the inlet paths 115 extend in the first direction (the longitudinal direction) of the support substrate in plan view.

First openings 116 for communicating the inlet paths 115 from the support substrate 102 to the first substrate member 106 are formed in the flexible member 101. An example of a method of forming the first opening 116 in the flexible member 101 is dry etching. The flexible member 101 contains resin. Example of the resin contained in the flexible member 101 are polyimide, polyamide, or the like.

In addition, a bottom surface (a surface facing the −Z direction) of the flexible member 101 is bonded to the upper surface (the surface facing the +Z direction) of the support substrate 102 so as to cover the concave portions 112. With the configuration as described above, in the case where an external force is applied to the flexible member 101 due to a pressure fluctuation or the like, which will be described later, the flexible member 101 can elastically deform toward the concave portion 112. Thereafter, the flexible member 101 can return from the elastically deformed shape to its original shape due to the elastic restoring force.

In addition, as illustrated in FIG. 6B3, the flexible member 101 may be configured to individually cover the concave portions 112. Accordingly, since the functions can be separated for each flexible member 101, for example, it becomes possible to thicken a portion to increase rigidity to make the flexible member 101 less likely to peel off.

A plurality of first flow paths [common supply flow paths (hereinafter simply referred to as the first flow paths)] 113 respectively communicating with the first openings 116, and second flow paths [individual supply flow paths (hereinafter referred to as the second flow paths)] 114 respectively and individually communicating with the first flow paths 113 are formed in the first substrate member 106. In the first substrate member 106, a plurality of accommodation spaces 107, each having the vibration plate 108 as a top surface, are arranged in the Y-axis direction. Each of the accommodation spaces 107 accommodates a plurality of pressure generating elements (for example, piezoelectric elements) 109 arranged on a bottom surface of the vibration plate 108.

Vibration plate openings 117 that communicate the second flow paths 114 from the first substrate member 106 to the second substrate member 110 are formed in the vibration plate 108. A plurality of pressure chambers 118 each having the vibration plate 108 as a bottom surface (a surface on the −Z direction side) is formed in the second substrate member 110. In the second substrate member 110, the plurality of discharge ports 111 communicating with the plurality of pressure chambers 118, respectively, are arranged in the Y-axis direction.

With the configuration as described above, if liquid is discharged from the first liquid discharge substrate 100 and the modification 1100 of the first liquid discharge substrate, the liquid passes from the inlet paths 115 through the first openings 116 and is supplied to the first flow paths 113. The liquid supplied to the first flow paths 113 passes through the second flow paths 114 and the vibration plate openings 117 and is supplied to the pressure chambers 118. Accordingly, the first flow paths 113 are flow paths that supply the liquid to the discharge ports 111 via the second flow paths.

The pressure generating element (for example, a piezoelectric element) 109 elastically deforms the vibration plate 108 in response to an electric signal received from a control unit in a main body of the liquid discharge apparatus 600, thereby changing the volume inside the pressure chamber 118. Accordingly, a pressure fluctuation is generated in the pressure chamber 118, the liquid in the pressure chamber 118 is pressurized, and droplets (for example, ink droplets) are discharged from the discharge ports 111 in the +Z direction. It should be noted that the liquid that has not been discharged from the discharge ports 111 is collected.

If a pressure fluctuation is generated, the flexible member 101, serving as one wall surface of the first flow path 113 (a partition separating the concave portion 112 and the first flow path 113), elastically deforms toward the concave portion 112, and thus the pressure fluctuation is attenuated. That is, the entire first flow path 113 functions as a damper. With the configuration as described above, it is possible to mitigate pressure fluctuations at the discharge ports other than the discharge ports from which the discharge operation has been performed, and to reduce the influence of crosstalk.

As illustrated in FIGS. 6A1 to 6B3, in the first liquid discharge substrate 100 and the modification 1100 of the first liquid discharge substrate, the support substrate 102, the first substrate member 106, and the second substrate member 110 are laminated via the bonding members. In the support substrate 102, the inlet paths 115, which are liquid supply flow paths, are formed. The flow paths (hereinafter referred to as the first flow paths) 113 capable of accommodating the liquid supplied from the inlet paths 115 are formed in the first substrate member 106 included in the flow path substrate 103. The plurality of pressure chambers 118 communicating with the first flow paths 113 are formed in the second substrate member 110. In the second substrate member 110 included in the flow path substrate 103, the plurality of discharge ports 111 that are arranged in the pressure chambers 118, respectively, and that are capable of discharging the liquid accommodated in the pressure chambers 118 are formed. A part of the wall surface of the first flow path 113 (the partition separating the concave portion 112 and the first flow path 113) is formed by the sheet-like flexible member 101. This sheet is stretched in the hollow portion defined by the support substrate 102 and the first substrate member 106 (that is, the space formed by the concave portion 112 and the first flow path 113).

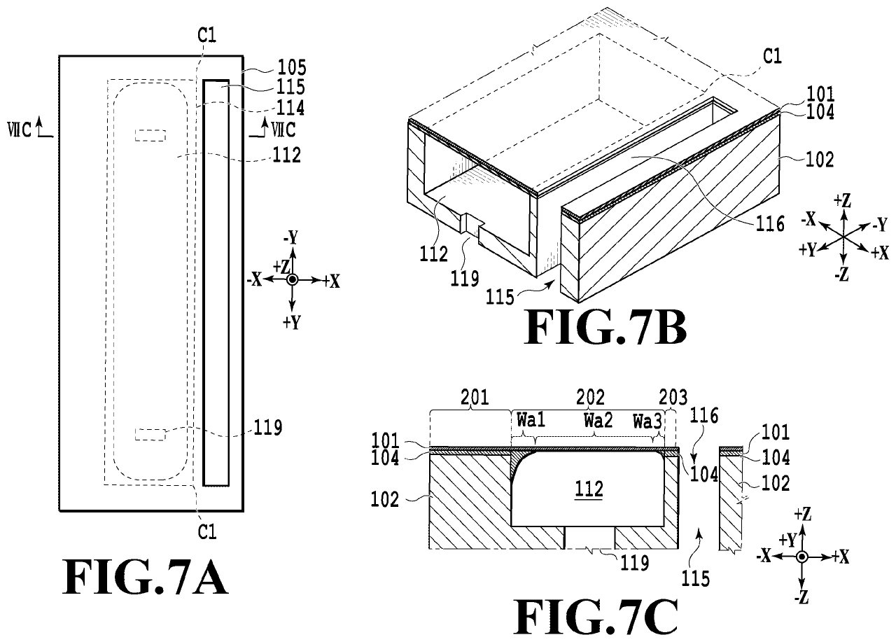

FIGS. 7A, 7B and 7C are schematic diagrams of a region and its vicinity that function as the damper in FIGS. 6A1 to 6B3. FIG. 7A illustrates a plan view corresponding to line VIB1-VIB1 in FIG. 6A1. FIG. 7B is a cross-sectional perspective view cut along line VIIC-VIIC in FIG. 7A. FIG. 7C illustrates a cross-sectional view corresponding to line VIIC-VIIC in FIG. 7A. As illustrated in FIG. 7C, the support substrate 102 includes an outer edge bonding portion 201 that supports the flexible member 101 so as to sandwich the flexible member 101 between the support substrate 102 and the first substrate member 106 (not illustrated). The outer edge bonding portion 201 is located on the outer periphery (outer edge portion) of the support substrate 102. In addition, the flexible member 101 covers the concave portion 112, and is bonded to an inlet path wall of the support substrate and the outer edge portion (outer edge bonding portion) along the first direction (longitudinal direction) of the support substrate via the first bonding member. In addition, the flexible member 101 includes a flexible portion 202 that is not supported by the support substrate 102 and the first substrate member 106, and that can be elastically deformed toward the concave portion 112 under an external force. The flexible portion 202 functions as a damper region (damper structure) for attenuating pressure fluctuations generated in discharging of the liquid. Furthermore, the bottom surface (the surface facing the −Z direction) of the flexible member 101 is supported by the support substrate 102, and a part of the top surface (the surface facing the +Z direction) of the flexible member 101 faces the inlet path 113. In addition, the flexible member 101 is supported by the inlet path wall 203. As for the bonding area between the flexible member 101 and the support substrate 102 in these regions, the outer edge bonding portion 201 is larger than the inlet path wall 203. In addition, in the flexible portion 202, there are protruding portions of the first bonding member 104 on the flexible member 101 and inner walls of the concave portion 112 (that is, the protruding portions are the portions of the first bonding member 104 that protrude into the concave portion in plan view). The protruding portion on the outer edge bonding portion side of the concave portion 112 in the −X direction is designated as Wa1, the protruding portion on the inlet path wall side of the concave portion 112 in the +X direction is designated as Wa3, and the region of the flexible member 101 located between Wa1 and Wa3 is designated as Wa2. Furthermore, the positions of the concave portion 112 and the inlet path 115 in the Y-axis direction in FIG. 7A are such that the concave portion 112=the inlet path 115. In this case, since the protruding portions change depending on the bonding area between the flexible member 101 and the support substrate 102, Wa1>Wa3 is established. Accordingly, the area of the inlet path wall 203 where the first bonding member 104 is in contact with the flexible member 101 is smaller than that of the outer edge bonding portion 201. Therefore, in the case where the flexible member 101 is elastically deformed, there is a possibility that the flexible member 101 peels off from the first bonding member 104. If the flexible member 101 peels off from the bonding member, the function of the flexible member 101 as a damper is reduced, and the substrates are separated from each other. Furthermore, compared to the first liquid discharge substrate 100, the modification 1100 of the first liquid discharge substrate 100 has a complex circulation structure in which liquid flows in one direction, and thus it is necessary to narrow the inlet path wall 203 to arrange the liquid flow paths at high density. Therefore, there is a higher possibility that the flexible member 101 peels off from the first bonding member 104. In view of the above situation, in the present embodiment, a characteristic structure is provided to adjust the protruding portions.

### <Mode of Providing Bonding Extension Portion>

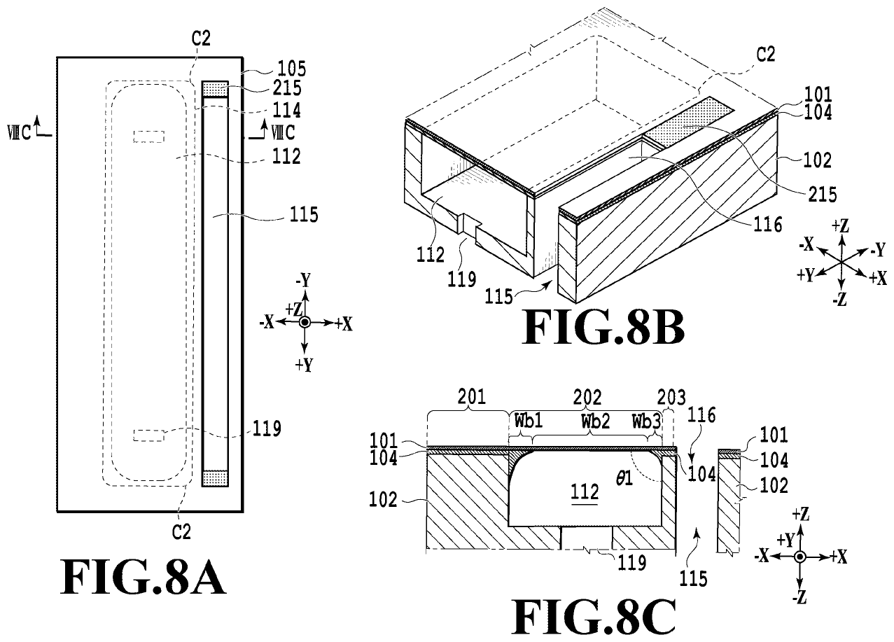

FIGS. 8A, 8B, and 8C are diagrams illustrating the first liquid discharge substrate 100 in the present embodiment and the modification 1100 of the first liquid discharge substrate. FIG. 8A illustrates a plan view, and FIG. 8B illustrates a cross-sectional perspective view cut along line VIIIC-VIIIC in FIG. 8A. FIG. 8C illustrates a cross-sectional view corresponding to line VIIIC-VIIIC in FIG. 8A.

As illustrated in FIG. 8A, compared to the schematic diagrams illustrated in FIGS. 7A to 7C, bonding extension portions 215 having a predetermined length from respective end portions of the inlet path 115 are provided in the Y-axis direction (the first direction (the longitudinal direction)) of the concave portion 112. In one embodiment, the bonding extension portions 215 can be provided from the respective end portions of the inlet path 115 toward the inside of the inlet path 115, so that the length of the inlet path 115 becomes shorter than the length of the concave portion 112.

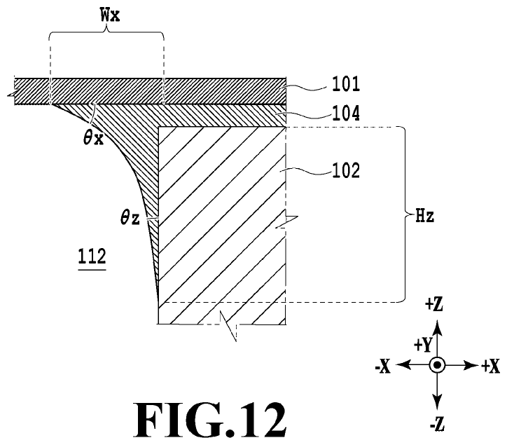

The protruding portion Wb3 on the inlet path wall 203 side of the concave portion 112 in the +X direction in the present embodiment corresponds to the portion of the first bonding member 104 that is crushed and flows in from the bonding extension portion 215. This portion is the first bonding member that is pushed out from the bonding extension portion 215 if the flexible member 101 and the support substrate 102 are bonded via the first bonding member 104. The protruding portion Wb3 of the first bonding member 104 has a larger spread than the protruding portion Wa3 illustrated in FIG. 7C. Therefore, the relationship of the protruding portion Wb3>Wa3 is established. In one embodiment, for example, the contact angle of the first bonding member 104 with respect to the side wall of the inlet path 115 (the inner wall of the concave portion 112) at the protruding portion can be 30° or less (details will be described later with reference to FIG. 12).

With the configuration as described above, the area where the first bonding member 104 and the flexible member 101 are in contact with each other inside the concave portion 112 of the inlet path wall 203 can be increased. Accordingly, since the bonding area between the flexible member 101 and the first bonding member 104 in the inlet path wall 203 is increased, the bonding strength can be improved. Thus, with the liquid discharge substrate of the present disclosure, the flexible member 101 and the first bonding member 104 can be firmly bonded to each other.

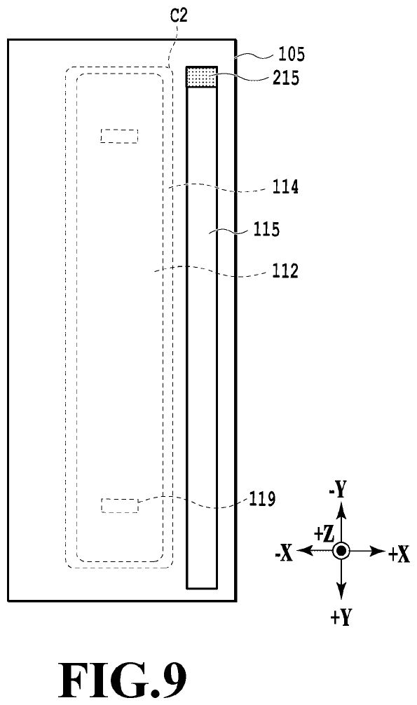

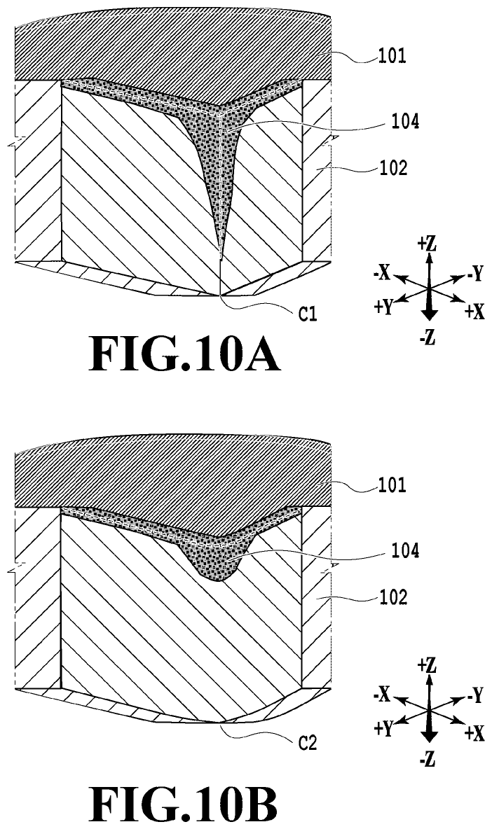

It should be noted that as illustrated in FIG. 9, the bonding extension portion 215 may be provided by changing the position of the inlet path 115 in the Y-axis direction (for example, by being moved in the +Y direction) without changing the lengths of the concave portion 112 and the inlet path 115 in the Y-axis direction. Accordingly, it becomes possible to widen the protruding portion Wb3 without changing the amount of liquid flowing in.

It should be noted that, since the purpose of providing the bonding extension portion 215 is to expand the bonding area between the flexible member 101 and the first bonding member 104 by having the protruding portion into the concave portion 112, the bonding extension portion 215 may be provided at any position in the Y-axis direction, which is the first direction (the longitudinal direction) of the inlet path. In addition, since the end portions of the inlet path 115 is farther from the flow path 114 than the center portion of the inlet path, pressure loss is less likely to occur even if the bonding extension portions are provided. Accordingly, in consideration of the pressure loss of the liquid flowing through the inlet path 115, it is more desirable to provide the bonding extension portion 215 at the end portions of the inlet path. The bonding extension portion 215 may be provided on at least one of the end portions of the inlet path. The bonding extension portion 215 in the present embodiment can be provided such that the length of the inlet path is 98% or less of the length of the concave portion 112. The length of the bonding extension portion 215 will be considered by taking a case where the bonding extension portion 215 is provided at the end portions of the inlet path 115 as an example. In this case, the maximum length of at least the bonding extension portion 215 can be set to a distance equal to the distance between the inner surface of the concave portion closest to the second flow path 114 in the X-axis direction in the case where the concave portion 112 and the second flow path 114 are overlapped in the Z-axis direction. The minimum length of the bonding extension portion 215 in the first direction (the longitudinal direction) can be set to the length of the bonding extension portion 215 with which the inlet path becomes 98% of the concave portion.

<Mode in which Bonding Member Protruding to End Portions of Concave Portion is Moved to Near Center of Concave Portion in Y-Axis Direction>

In addition, in order to prevent peeling between the flexible member 101 and the first bonding member 104 due to elastic deformation of the flexible member 101 in the inlet path wall 203, it is necessary to uniformly provide the protruding portion Wb3 of the first bonding member 104 on the inlet path wall side of the concave portion 112. In particular, it is necessary to expand the area of the protruding portion near the center in the Y-axis direction, which is likely to be elastically deformed. Therefore, the first bonding member 104 protruding to the end portions of the concave portion 112 adjacent to the bonding extension portion 215 needs to be moved to near the center of the concave portion 112 in the Y-axis direction.

The present embodiment will be described with reference to FIGS. 10A and 10B. FIG. 10A is a schematic perspective view of the bottom surface (the surface on the −Z direction side) of the flexible member 101 as seen from the bottom side (the −Z direction side) of the concave portion 112 at a corner C1 where the X-axis direction and the Y-axis direction meet as illustrated in FIG. 7A. On the other hand, FIG. 10B is a schematic perspective view of the bottom surface (the surface on the −Z direction side) of the flexible member 101 as seen from the bottom side (the −Z direction side) of the concave portion 112 at a corner C2 where the X-axis direction and the Y-axis direction meet as illustrated in FIG. 8A.

While the corner C1 has a rectangular shape, the corner C2 has a curved surface shape that is a substantially circular R-shape in plan view, as illustrated in FIG. 8A. By forming the corner C2 in the curved shape that is the substantially circular R-shape, it is possible to prevent the protruding first bonding member 104 from gathering in the −Z direction of the corner C due to capillary action. Therefore, it is desirable that the corner portions of the concave portion 112 where the X-axis direction and the Y-axis direction meet have a curved surface shape that is a substantially circular R-shape like the corners C2. In the liquid discharge substrate of the present disclosure, the size (the radius of curvature or the like) of the shape of at least one corner potion of four corner portions C2 may be different as long as the shape is a curved surface shape that is a substantially circular R-shape. In the case where the radii of curvature are made different, it is desirable to set the radii of curvature R so that the relationship of R (the corner C1)<R (the corner C2) is established.

Furthermore, in one embodiment, as illustrated in FIG. 8C, an angle θ1 (at the time when the liquid discharge substrate is manufactured) between the flexible member 101 and the inner surface of the concave portion 112 can be 100° or less. In another embodiment, the angle θ1 can be 55° or more and 100° or less. This promotes the movement of the first bonding member 104 that is compressed and flows in from the bonding extension portion 215 to near the center of the concave portion 112 in the Y-axis direction due to capillary action.

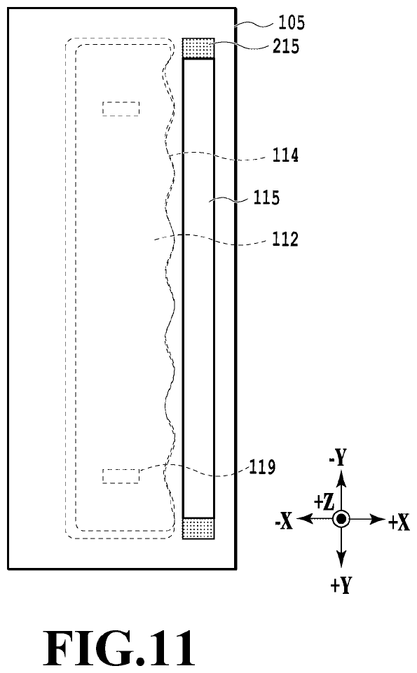

Furthermore, one embodiment, as illustrated in FIGS. 8A, 8B, 8C and 9, the wall of the concave portion 112 on the inlet path side can be substantially straight in the Y-axis direction (that is, the side wall of the concave portion 112 extending in the first direction (the longitudinal direction) can be substantially straight in plan view). Accordingly, since the surface area is reduced compared to, for example, a corrugated wall as illustrated in FIG. 11, it possible to easily move the first bonding member 104 protruding to the end portions of the concave portion adjacent to the bonding extension portion 215 to near the center of the concave portion 112 in the Y-axis direction.

Furthermore, as illustrated in FIG. 12, which is an enlarged view of the Wb3 portion in FIG. 8C, a contact angle θx between the first bonding member 104 and the flexible member 101, and a contact angle θz of the inner wall of the concave portion 112 can be 30° or less. In one embodiment, the contact angle θx and the contact angle θz can be 0° or more and 30° or less. Since this promotes capillary action occurring between the flexible member 101 and the inner wall of the concave portion 112, it becomes possible to easily move the first bonding member 104 protruding to the end portions of the concave portions 112 adjacent to the bonding extension portion 215 to near the center of the concave portion 112 in the Y-axis direction.

### <Bonding Member>

Hereinafter, the first bonding member 104 and the second bonding member 105 will be described. In the case where there is no need to particularly distinguish between the first bonding member 104 and the second bonding member 105, they will be simply written as “bonding members.” In addition, in the case where there is no need to particularly distinguish between the support substrate 102, the first substrate member 106, and the second substrate member 110, they will be simply referred to as “substrates.”

An organic or inorganic material can be used for the bonding members. Depending on the material used for the substrates, deterioration at high temperatures may become an issue, and thus organic materials that allow bonding at relatively low temperatures is desirable, since they provide greater freedom in the materials of the substrates. Although adhesive materials can be used as organic bonding materials, materials that is cured in a bonded state are suitable, as this makes it easier to increase the bonding strength. Thermoplastic materials can be used, since they are materials that soften and adhere by heating, and thereafter cured if the temperature decreases, which allows easy handling. A material that is cured due to a chemical reaction after bonding can be also used, as this makes it easier to increase the bonding strength. Thermosetting materials can also be used, since the curing reaction is easy to control.

Epoxy, acrylic, urethane, silicone, benzocyclobutene, polyimide, polyamide, polyamideimide, cyanoacrylate, phenol, melamine, styrene, cyclized rubber, a mixture thereof, or the like can be used as the materials for the bonding members. Among these, resin containing epoxy, silicone, benzocyclobutene, and polyimide as main components can be used desirably, since they have excellent chemical resistance.

The type of epoxy is not particularly limited. For example, bisphenol type epoxy, novolac type epoxy, epoxy polyol type epoxy, alicyclic epoxy, glycidyl type epoxy, urethane modified epoxy, chelate modified epoxy, rubber modified epoxy, or a mixture thereof can be used.

Silicone is not particularly limited. For example, condensation type silicones or addition type silicones can be used. Among these, addition type silicones can be used, since they have little shrinkage on curing. For example, epoxy-modified silicone, acrylic-modified silicone, methyl-based silicone, phenyl-based silicone, methylphenyl-based silicone, alkyd-modified silicone, polyester-modified silicone, or a mixture thereof can be used.

The polyimide is not particularly limited. A polyimide having thermoplastic properties may be used in the form of a film. Polyamic acid may be used as a precursor. It is desirable to use a precursor and then cures it after bonding, as this makes it easier to increase the bonding strength.

A filler may be added to the bonding members. For example, in one embodiment, a fibrous filler can be used. This is because the effect of suppressing defects such as breakage of the bonding members is relatively high. Examples of the fibrous filler include carbon fiber, metal fiber, glass fibers, cellulose fiber, or the like.

The substrates may have a functional layer to improve chemical resistance or to improve bondability to the bonding members. The functional layer may be arranged to a part of a substrate. The functional layer may be arranged to the entire surface of a substrate. A coupling agent may be arranged between the support substrate 102 and the flexible member 101, and between the first substrate member 106 and the flexible member 101. By selecting a coupling agent that matches the substrate material or functional layer material and the bonding member, it is possible to form a covalent bond, and thus the effect of increasing the bondability can be obtained. Of course, a coupling agent may be arranged between the flexible member 101 and the first substrate member 106.

In addition, in the liquid discharge substrate of the present disclosure, the bonding members may be made of the same material. Accordingly, the first bonding member 104 and the second bonding member 105 can obtain the same effect as the flexible member 101. For example, in the case where stress is applied due to heating or the like, it is possible to prevent the stress from being biased to the bonding members on one side, and to improve the bonding strength. On the other hand, the bonding members may be made of different materials. Accordingly, the first bonding member 104 and the second bonding member 105 can be functionally separated. For example, by using, for the first bonding member 104, a flexible material that absorbs vibrations of the flexible member 101, peeling due to the vibrations can be prevented, and by using a material with high adhesion for the second bonding member 105, the reliability can be improved.

### Second Embodiment

Hereinafter, a second embodiment of the technique of the present disclosure will be described with reference to the drawings. In the following description, the same reference numbers and names are used for configurations that are similar to or correspond to those in the first embodiment, descriptions thereof will be omitted as appropriate, and the differences will be mainly described. The present embodiment differs from the first embodiment in that a groove (a groove portion, hereinafter referred to as the groove portion) is formed in the outer edge bonding portion 201.

According to the first embodiment, by expanding the protruding portion on the concave portion 112 on the inlet path wall side (in the +X direction), the relationship between the protruding portions Wb3>Wa3 is established, and the bonding strength of the inlet path wall 203 can be improved. However, as illustrated in FIG. 8C, Wb2, which is located between the protruding portion Wb1 on the outer edge bonding portion side in the −X direction and the protruding portion Wb3 on the concave portion side of the inlet path wall 203, may have a narrower width in the X-axis direction than Wa2 illustrated in FIG. 7C. In this case, a further configuration is desired that suppresses the effects of crosstalk without reducing the function as a damper.

<Mode in which Groove Portion is Provided in Outer Edge Bonding Portion of Support Substrate>

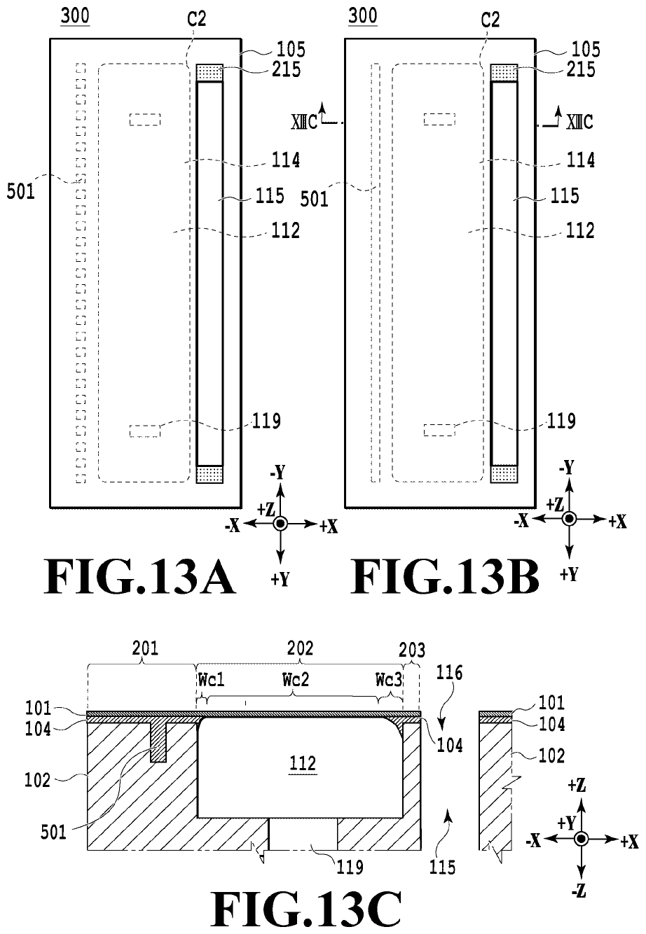

FIGS. 13A, 13B, and 13C are diagrams illustrating a second liquid discharge substrate 300 in the present embodiment. FIGS. 13A and 13B illustrate plan views of the second liquid discharge substrate 300. FIG. 13C illustrates a cross-sectional view corresponding to line VIIIC-VIIIC in FIG. 13B.

As illustrated in FIGS. 13A, 13B, and 13C, one or more groove portions 501 that can accommodate excess first bonding member 104 are formed in the outer edge bonding portion 201 in the present embodiment. The shape of the groove portion 501 may be a rectangular tube as illustrated in FIG. 13A, or a cylindrical shape that is not illustrated. In addition, the shape of the groove portion 501 may be a shape in which the groove portion 501 is continuously formed along an inner side of the outer edge bonding portion 201 as illustrated in FIG. 13B. An example of a method for forming the groove portion 501 in the support substrate 102 is dry etching. The position of the groove portion 501 is not limited as long as the groove portion 501 is within the outer edge bonding portion 201. For example, the distance from the end portion of the outer edge bonding portion 201 on the concave portion side to the groove portion 501 needs to be a certain distance to ensure the bonding area. In one embodiment, the distance can be set to be equal to or greater than the widest distance in the X-axis direction of the inlet path wall 203. As illustrated in FIG. 13C, in the outer edge bonding portion 201, the first bonding member 104 flows into an inner peripheral surface of the groove portion 501.

With the configuration as described above, excess first bonding member 104 can be accommodated inside the groove portion 501. Accordingly, a protruding portion Wc1 on the outer edge bonding portion side of the concave portion 112 in the −X direction can be made narrower than Wa1 in FIG. 7C. Therefore, the region of Wc2 in the present embodiment is expanded, and the bonding strength of the inlet path wall 203 can be improved without impairing the function as a damper.

In addition, in the present embodiment, the outer edge bonding portion has a large area where the first bonding member 104 is in contact with the flexible member 101, and thus does not affect the bonding strength. Accordingly, the protruding portions into the concave portion can have the relationship Wc1<Wc3. That is, the bonding area between the outer edge bonding portion and the flexible member is larger than the bonding area between the inlet path wall and the flexible member, and in a width direction (a second direction) of the concave portion, the width of the protruding portion of the first bonding member in the width direction (the second direction) on the outer edge bonding side (outer edge side) is smaller than that on the opposing inlet path side. In addition to providing the groove portion 501, the relationship Wc1<Wc3 can also be obtained by designing the substantially circular shape (the curved surface shape that is an R-shape) of the corner portions of the concave portion 112 on the outer edge bonding portion side to be different from the substantially circular shape (the curved shape that is an R-shape) of the corner portions on the inlet path wall 203 side. By providing the groove portion 501, the total amount of the bonding member that protrudes to the outer edge bonding portion side of the concave portion 112 is reduced, and Wc1<Wc3 can be established. In addition, by reducing the radius of curvature of the corner portions of the concave portion 112 on the outer edge bonding portion side, the capillary force is increased, and the corner portions move toward the bottom side of the concave portion to establish Wc1<Wc3. Accordingly, the bonding strength of the inlet path wall 203 can be improved without impairing the function as a damper.

Furthermore, in one embodiment, as illustrated in FIG. 12, the contact angle θx between the first bonding member 104 and the flexible member 101 (a flexible member side contact angle) and the contact angle θz of the inner wall of the concave portion 112 (an inlet path side contact angle) satisfy θx >θz. That is, the contact angle of the first bonding member may be larger on the flexible member side than on the inlet path wall side. Accordingly, the lengths of the protruding portion of Wc3 satisfy Wx<Hz, where Wx is the contact length between the first bonding member 104 and the flexible member 101, and Hz is the contact length with the inner wall of the concave portion 112 (a side wall of the inlet path 115). Accordingly, it is possible to prevent the first bonding member 104 from expanding too far onto the bottom surface (the surface facing the −Z direction) of the flexible member 101. Therefore, it is possible to prevent the width of the position Wc2 in the flexible portion 202 that is likely to be elastically deformed from being narrowed. In addition, the first bonding member 104 in contact with the inner wall of the concave portion 112 is less likely to affect the position Wc2 that is likely to be elastically deformed. Therefore, by increasing Hz, it is possible to strengthen the protruding portions that support the elastic deformation of the Wx portion. In order to define Wx within a range in which damping performance is not reduced, Wx is desirable within a range in which it does not overlap with the second flow path 114 in the case where the elements of the liquid discharge substrate are stacked in the Z-axis direction. In addition, it is desirable that Hz is within a range where it does not come into contact with the bottom of the concave portion 112 (the surface in the −Z direction). This is because in the case where Hz comes into contact with the bottom of the concave portion, capillary force is exerted at the corner portions where the bottom intersects with the inner surface of the concave portion, causing the bonding member required for the bonding portion on the upper surface of the concave portion to move to the bottom. It should be noted that the above-described relationship between Wx and Hz also applies to the case where the groove portion 501 is not provided.

### <Manufacturing Method of Liquid Discharge Substrate>

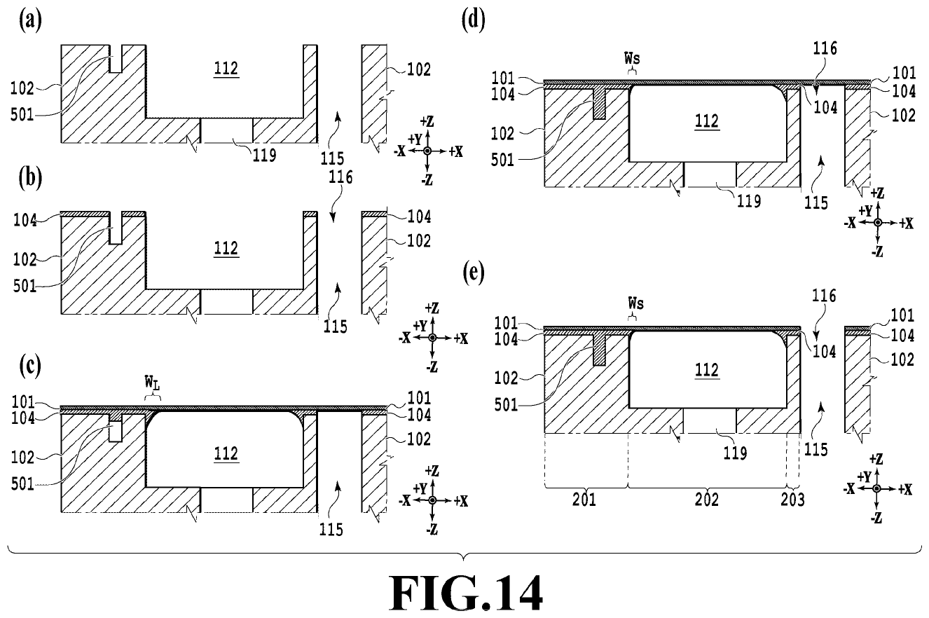

FIG. 14 is diagram for describing an example of manufacturing processes for the second liquid discharge substrate 300 in the second embodiment illustrated in FIGS. 13A to 13C.

FIG. 14 (a) is a diagram illustrating the support substrate 102 of the second liquid discharge substrate 300 illustrated in FIGS. 13A to 13C, and illustrates a process of preparing the support substrate 102. The dimensions of the support substrate 102 are assumed to have the following values.
the support substrate 102: Z-direction thickness 600 to 800 μm,
the concave portion 112: 300 to 600×20,000 to 3,000 μm×Z-direction depth 200 to 400 μm,
the inlet path 115: 200 to 400×20,000 to 30,000 μm×Z-direction depth 200 to 400 μm,
the groove portion 501: 20 to 100×20 to 30,000 μm×Z-direction depth 50 to 300 μm,
the X-direction width of the outer edge bonding portion 201: 800 to 1500 μm,
the X-direction width of the inlet path wall 203: 50 to 300 μm,
the protruding portion Wc1 on the outer edge bonding portion side of the concave portion 112: 0 to 10 μm, and
the protruding portion Wc3 of the concave portion 112 on the inlet path wall side: 10 to 50 μm.

FIG. 14 (b) is a diagram illustrating a first process. As illustrated in FIG. 14 (b), in the first process, the uncured first bonding member 104 having a thickness of about 1 to 5 μm is applied to a region of the surface of the support substrate 102 in which the concave portion 112 is formed, where the concave portion 112, the inlet path 115, and the groove portion 501 are not formed. As a method of applying the uncured first bonding member 104, a common method for resin members can be used. For example, in the case where the first bonding member 104 is to be applied to the entire surface of the support substrate 102, the first bonding member 104 is applied by spin coating, spraying, or the like. In the case where the first bonding member 104 is to be applied to a part of the support substrate 102, the first bonding member 104 is applied by a dispenser, screen printing, or by transferring a dry film of the bonding member. Furthermore, as the material of the first bonding member 104 in the manufacturing method of the liquid discharge substrate illustrated in FIG. 14, a thermosetting-type material can be used, since viscosity reduction due to heating is required.

FIG. 14 (c) is a diagram illustrating a second process. As illustrated in FIG. 14C, in the second process, a sheet-like flexible member 101 is placed on the upper surface (the surface facing the +Z direction) of the first bonding member 104, and the support substrate 102 and the flexible member 101 are bonded by the first bonding member 104. The first bonding member 104 is crushed to a thickness of about 0.1 μm, gathers in the +Z direction in the groove portion 501, and protrudes to the outer edge bonding portion side and the inlet path side inside the concave portion 112. At this time, the width W_{L} in the X-axis direction of the first bonding member 104 protruding to the outer edge bonding portion side of the concave portion 112 is wide. In addition, the bonding of the support substrate 102 and the flexible member 101 may be performed under reduced pressure. Accordingly, the void in the −Z direction of the groove portion 501 is in a reduced pressure state.

On the other hand, in FIG. 14 (c), the flexible member 101 is laminated in a state where the portion corresponding to the first opening 116 is not opened. At the point in time of FIG. 14 (e) that will be described later, the portion that will become the first opening 116 in the future is opened. As an example of a method of forming the first opening 116, there is a method of forming the first opening 116 by performing dry etching using a mask material (not illustrated). If the flexible member 101 is photosensitive resin, a method of patterning by exposure may be used.

FIG. 14 (d) is a diagram illustrating a third process. In the third process, the effect of increasing the bondability can be obtained by curing the first bonding member 104 using a chemical reaction. Furthermore, in the third process, the first bonding member 104 is cured under a pressure higher than the pressure at the time of bonding in the second process of FIG. 14 (c). Accordingly, a pressure difference is created between a void portion in the −Z direction of the groove portion 501 that has been in the reduced pressure state and the concave portion 112, and the first bonding member 104 protruding to the outer edge bonding portion side of the concave portion 112 is pulled into the void portion in the −Z direction of the groove portion 501. As a result, the relationship W_{L}>W_{S} is established. In addition, the first bonding member 104 protruding into the concave portion 112 in FIGS. 14 (c) and (d) has the contact angles θx and θz and the contact lengths Wx and Hz of the first bonding member 104 as illustrated in FIG. 12. These have a relationship of the flexible member side contact angle (ex): the inlet path side contact angle (θz)=2 to 5:1, and a relationship of Wx:Hz=1:2 to 5. Accordingly, since it is possible to prevent the first bonding member 104 from excessively protruding to the flexible member 101, the decrease in the flexibility can be suppressed. Furthermore, the first bonding member 104 can increase the adhesion between the flexible member 101 and the support substrate 102.

FIG. 14 (e) is a diagram illustrating a fourth process. As illustrated in FIG. 14E, in the fourth process, the first opening 116 is formed in the flexible member 101. As an example of a method of forming the first opening 116, there is a method of forming the first opening 116 by performing dry etching using a mask material (not illustrated). If the flexible member 101 is photosensitive resin, a method of patterning by exposure may be used.

The liquid discharge substrate 100 (1100) can be manufactured by bonding the above-described flow path substrate 103 to the substrate including the support substrate 102, the flexible member 101, and the first bonding member 104 obtained by the above procedure via the second bonding member 105.

In the above-described manufacturing method, although the second embodiment in which the groove portion is provided has been described, the liquid discharge substrate in the first embodiment can also be manufactured in a similar procedure using the support substrate 102 in which no groove portion is provided. That is, the liquid discharge substrate in the first embodiment can be manufactured using the support substrate 102 in which no groove portion is provided, in a similar procedure to that illustrated in FIG. 14.

### Example

Hereinafter, an example of the manufacturing method illustrated in FIG. 14 will be described. Hereinafter, although a description will be given with reference to FIG. 14, one technical example will be merely described. In particular, the technical scope of the present disclosure is not limited to the following example.

As illustrated in FIG. 14 (a), a 625 μm silicon substrate was prepared as the support substrate 102. A positive resist was exposed and developed on both sides of this silicon substrate. Then, by dry etching, the concave portion 112 having a depth of 400 μm, a width of 500 μm, and a length of 26,500 μm, the inlet path 113 having a depth of 400 μm, a width of 250 μm, and a length of 25800 μm, and the groove portion 501 having a depth of 200 μm, a width of 50 μm, and a length of 50 μm were formed. In addition, the concave portion in the present example was formed so that the angle θ1 formed between the inner surface of the concave portion and the flexible member 101 that is bonded so as to cover the concave portion 112, which will be described later, was 93°.

Next, as illustrated in FIG. 14 (b), the uncured first bonding member 104 having a thickness of 3 μm was made into a dry film and transferred onto the support substrate 102. In the present example, a thermosetting resin material is applied as the first bonding member 104.

Next, as illustrated in FIG. 14 (c), the support substrate 102 and the flexible member 101 were bonded under reduced pressure by crushing the uncured first bonding member 104 until the thickness was 0.1 μm. In addition, the void in the −Z direction of the groove portion 501 is in a reduced pressure state. As the flexible member 101, for example, a polyimide film having a thickness of 3 μm was used. The flexible member 101 was formed by laminating while applying pressure. The lamination temperature was set to a temperature at which the uncured first bonding member 104 was not be cured.

Next, as illustrated in FIG. 14 (d), the uncured first bonding member 104 was cured. Here, a heat treatment was performed at 250° C. by using an oven with a nitrogen atmosphere under a pressure higher than the pressure at the time of bonding in FIG. 14 (c). Accordingly, a pressure difference is created between the void portion in the −Z direction of the groove portion 501 that has been in the reduced pressure state and the concave portion 112, and the first bonding member 104 protruding to the outer edge bonding portion side of the concave portion 112 is pulled into the void portion in the −Z direction of the groove portion 501. As a result, the relationship W_{L}>W_{S} is established. In addition, the first bonding member 104 protruding inside the concave portion in FIG. 14 (d) in the present example has the contact angle (the flexible member side contact angle) θx with the flexible member 101 and the contact angle (the inlet path wall side contact angle) θz with the inner wall (on the inlet path wall side) of the concave portion 112 as illustrated in FIG. 12. These are θx=4° and θz=2°, and are in the relationship θx:θz=2:1. In addition, the lengths of the protruding portion in the present example are Wx=12 μm and Hz=28 μm, where Wx is the length of contact between the first bonding member 104 and the flexible member 101, and Hz is the length of contact with the inner wall of the concave portion 112, and are in the relationship Wx:Hz=1:2.

Next, as illustrated in FIG. 14 (e), a mask pattern (not illustrated) was formed on the flexible member 101. Thereafter, the opening 116 was formed by a commonly known reactive dry etching method using a mixed gas of CF₄ gas (tetrafluoromethane gas) and oxygen gas.

The bonding extension portion 215 in the present example was provided so that the length of the inlet path is 98% or less of the length of the concave portion 112.

Using the liquid discharge head 1 to which the liquid discharge substrate 100 manufactured as described above was attached, a discharge operation was performed for a predetermined period of time. On that occasion, it was possible to perform a stable discharge operation for the predetermined period of time. Furthermore, after the discharge operation was completed, no peeling was observed between the flexible member 101 and the first bonding member 104.

As described above, according to the first liquid discharge substrate 100 and the modification 1100 of the first liquid discharge substrate, the bonding extension portions 215 are provided in the regions where the length of the inlet path 115 in the Y-axis direction (the first direction (the longitudinal direction)) is shortened relative to the concave portion 112. With the configuration as described above, in the case where the flexible member 101 is bonded to the support substrate 102 via the first bonding member 104, the first bonding member 104 protrudes from the bonding extension portions 215 to the inlet path wall side of the concave portion 112. Accordingly, since the bonding area between the flexible member 101 and the first bonding member 104 is increased in the inlet path wall 203, the bonding strength can be improved compared to conventional cases.

Furthermore, according to the liquid discharge substrate 100 manufactured in the present example, the groove portion 501 is provided in the outer edge bonding portion 201. With the configuration as described above, the excess first bonding member 104 can be accommodated inside the groove portion 501. Accordingly, the protruding portion on the outer edge bonding portion side of the concave portion 112 can be narrowed. Accordingly, the bonding strength of the inlet path wall 203 can be improved without impairing the function as a damper realized by the protruding portion.

### Other Embodiments

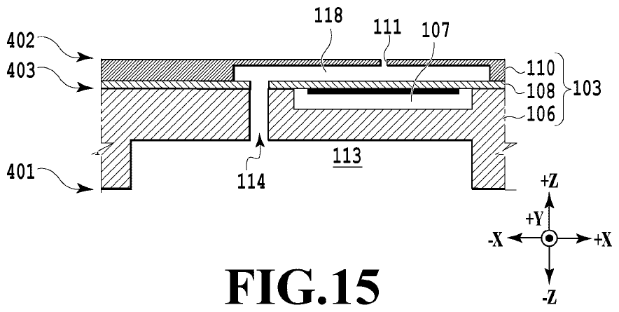

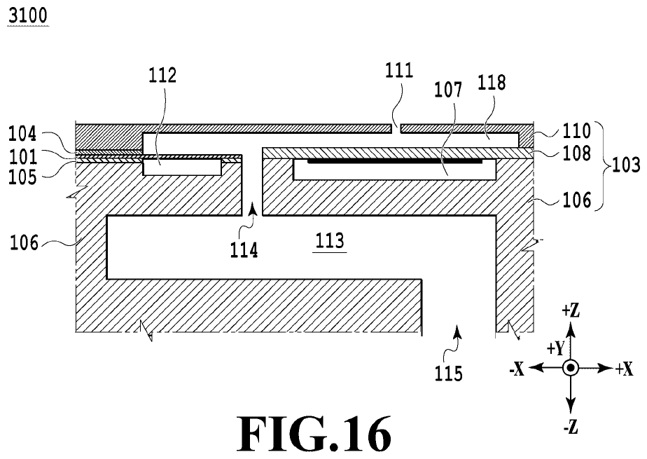

As described above, the first embodiment and the second embodiment have illustrated the configuration in which the flexible member 101 is formed on a first surface 401, which corresponds to the bottom surface side in the −Z direction of the flow path substrate 103 illustrated in FIG. 15. However, the surface on which the flexible member 101 and the support substrate 102 are formed is not limited to the first surface 401. For example, as in a schematic cross-sectional view of a liquid discharge substrate 3100 in another mode of the present embodiment illustrated in FIG. 16, the flexible member 101 and the support substrate 102 may be formed on a third surface 403, which corresponds to the same layer as the vibration plate of the flow path substrate 103 illustrated in FIG. 15. In this case, the upper surface (the surface facing the +Z direction) of the flow path substrate 103 includes a damper region where the flexible member 101 is provided, and a drive region where the accommodation space 107 and the vibration plate 108 are provided. In the configuration of FIG. 16, the second substrate member 110 having the discharge port 111, the flexible member 101, and the support substrate having the concave portion 112 and the individual supply flow path (the second flow path) 114 are laminated in this order.

The above embodiments may be implemented in combination as appropriate.

In the above embodiments, each of the support substrate 102, the first substrate member 106, and the second substrate member 110 is a separate member, but they do not need to be separate members. For example, the support substrate 102, the first substrate member 106, and the second substrate member 110 may be included in a single substrate.

In the above embodiments, dry etching has been cited as an example of the method of forming the first opening 116 and the groove portion 501 in the flexible member 101. As another example, if the flexible member 101 contains photosensitive resin, an example can be given in which the first opening 116 and the groove portion 501 are formed by patterning through exposure.

In the above embodiments, a piezoelectric system using a piezoelectric element has been given as an example of a driving unit for applying pressure to the liquid (ink) in the pressure chamber. Other examples of the driving unit for applying pressure to the ink in the pressure chamber include a method that utilizes electrostatic force, a method that uses a heating element, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to provide a technique for suppressing peeling of a flexible member that functions as a damper in the case where the flexible member is arranged on a liquid discharge substrate.

This application claims the benefit of Japanese Patent Application No. 2025-043764, filed Mar. 18, 2025, which is hereby incorporated by reference herein in its entirety.

What is claimed is:

1. A liquid discharge substrate comprising:
a flow path substrate including a discharge port that discharges liquid and a flow path that supplies the liquid to the discharge port;
a support substrate including an inlet path that communicates with the flow path, a concave portion provided corresponding to at least a part of the flow path, and an inlet path wall provided between the inlet path and the concave portion; and
a flexible member that covers the concave portion, and is bonded to the inlet path wall of the support substrate and to an outer edge portion of the support substrate along a first direction via a first bonding member,
wherein the support substrate includes, in plan view, the inlet path extending in the first direction of the support substrate, and a bonding extension portion adjacent to the inlet path in the first direction and adjacent to an end portion of the concave portion in a second direction intersecting the first direction, and
the first bonding member includes, in plan view, protruding portions that protrude into the concave portion.

2. The liquid discharge substrate according to claim 1, wherein a groove is formed in the outer edge portion.

3. The liquid discharge substrate according to claim 1, wherein a bonding area between the outer edge portion and the flexible member is larger than a bonding area between the inlet path wall and the flexible member, and in the second direction, a width of one of the protruding portions of the first bonding member on the outer edge portion side is smaller than a width of another of the protruding portions of the first bonding member on an opposing inlet path side.

4. The liquid discharge substrate according to claim 1, wherein corner portions of the concave portion have R-shapes in plan view.

5. The liquid discharge substrate according to claim 1, wherein an angle θ1 formed between the flexible member and an inner surface of the concave portion is 100° or less.

6. The liquid discharge substrate according to claim 1, wherein a side wall of the concave portion extending in the first direction is substantially straight in plan view.

7. The liquid discharge substrate according to claim 1, wherein a contact angle of the first bonding member with respect to a side wall of the inlet path at the protruding portion is 30° or less.

8. The liquid discharge substrate according to claim 7, wherein in one of the protruding portions, a contact angle θx of the first bonding member with respect to the flexible member is larger than a contact angle θz of the first bonding member with respect to the side wall of the inlet path.

9. The liquid discharge substrate according to claim 8, wherein θx:θz=2:1 to 5:1.

10. The liquid discharge substrate according to claim 1, wherein in one of the protruding portions, Wx:Hz=2:1 to 5:1, where a length along a surface of the flexible member is Wx, and a length along the side wall of the inlet path is Hz.

11. The liquid discharge substrate according to claim 1, wherein a length of the inlet path in the first direction is 98% or less of a length of the concave portion.

12. The liquid discharge substrate according to claim 2, wherein a plurality of the grooves are arranged along the concave portion.

13. The liquid discharge substrate according to claim 2, wherein the groove is continuously provided along the concave portion.

14. The liquid discharge substrate according to claim 1, wherein the flow path substrate including a plurality of the discharge ports, a plurality of pressure chambers corresponding to the plurality of the discharge ports, and a driving unit arranged in the pressure chambers to apply pressure to the liquid to discharge the liquid,
a second bonding member that bonds the flow path substrate and the flexible member,
the flexible member,
the first bonding member, and
the support substrate are laminated in this order.

15. The liquid discharge substrate according to claim 1, comprising the flow path substrate, the flexible member, and the support substrate laminated in this order.

16. A liquid discharge head comprising:
a liquid discharge substrate including:
a flow path substrate including a discharge port that discharges liquid and a flow path that supplies the liquid to the discharge port;
a support substrate including an inlet path that communicates with the flow path, a concave portion provided corresponding to at least a part of the flow path, and an inlet path wall provided between the inlet path and the concave portion; and
a flexible member that covers the concave portion, and is bonded to the inlet path wall of the support substrate and to an outer edge portion of the support substrate along a first direction via a first bonding member,
the support substrate including, in plan view, the inlet path extending in the first direction of the support substrate, and a bonding extension portion adjacent to the inlet path in the first direction and adjacent to an end portion of the concave portion in a second direction intersecting the first direction,
the first bonding member including, in plan view, protruding portions that protrude into the concave portion, and
an electric connection portion that sends power and control signals to the liquid discharge substrate.
